(19) United States
(12) Patent Application Publication
(10) Pub. No.: US 2014/0284006 A1
(43) Pub. Date: Sep. 25, 2014

(54) SAFETY ROPE ASSEMBLY FOR WINDOW CURTAIN

(71) Applicants: A-Nan Chen, Lukang Township (TW); CHING FENG HOME FASHIONS CO., LTD., Fuxing Shiang (TW)

(72) Inventors: WEN YING LIANG, Fuxing Shiang (TW); A-NAN CHEN, Lukang Township (TW)

(73) Assignees: CHING FENG HOME FASHIONS CO., LTD., Fuxing Shinag (TW); A-Nan Chen, Lukang Township (TW)

(21) Appl. No.: 14/033,505

(22) Filed: Sep. 22, 2013

(30) Foreign Application Priority Data
Mar. 22, 2013 (TW) 102205400

(51) Int. Cl. E06B 9/262

(52) U.S. Cl. CPC E06B 9/262
USPC 160/178.1 R

(57) ABSTRACT

A safety rope assembly for curtains includes multiple control units wrapped to multiple transmission units in the head box. Multiple slats extend through the ring-shaped support ropes. When the control units are operated, the transmission ropes are restricted by the separation ropes and cannot be pulled easily out to ensure that the transmission ropes do not cause dangerous situation to kids. The transmission ropes are operated steadily and effectively.

### FIELD OF THE INVENTION

The present invention relates to a rope assembly, and more particularly, to a safety rope assembly for a window curtain.

### BACKGROUND OF THE INVENTION

The conventional window curtain 50 is disclosed in FIG. 6 and generally comprises a set of blinds 51, transmission ropes 52 and operation ropes 53, wherein the operation ropes 53 are connected to the transmission ropes 52. The blinds 51 include multiple slats 54 and the transmission ropes 52 extend through the slats 54 and are connected between the head box and the bottom bar of the window curtain 50. The operation ropes 53 are connected to the operation unit in the head box. When the users pull the operation ropes 53, the blinds 51 move up and down by the cooperation of the operation ropes 53 and the transmission ropes 52.

FIGS. 7 and 8 show another conventional window curtain 50 which comprise a set of blinds 51, transmission ropes 52 and operation ropes 53, wherein two rings 56 are formed at two ends of each support rope 55 which is supported on the underside of each slat 54. The transmission ropes 52 are connected to the bottom bar and securely extend through the rings 56 and are connected to the operation ropes 53. By operating the operation ropes 53, the blinds 51 move up and down.

However, the operation ropes 53 are connected to the transmission unit in the head box, and the set of blinds is connected to the operation ropes by the transmission ropes. The transmission ropes 52 are exposed beyond the blinds so that the transmission ropes 52 become a potential risk for kids playing around the window curtain when the transmission ropes 52 are pulled out as shown in FIGS. 6 and 8.

The present invention intends to provide a safety rope assembly for a window curtain to improve the shortcoming of the above mentioned conventional window curtains.

### SUMMARY OF THE INVENTION

The present invention relates to a safety rope assembly for curtains and comprises multiple control units, and each control unit comprises multiple separation ropes, multiple transmission ropes and multiple support ropes. Each of the separation ropes has a side rope located on outside thereof, and multiple connection ropes are connected between the side rope and the separation rope. The support ropes are connected between the separation ropes and support the slats. The transmission ropes alternatively extend between the connection ropes. The side ropes each are connected to one end of the connection rope corresponding thereto.

Preferably, the connection ropes are rings and the transmission ropes extend through the rings.

Preferably, the transmission ropes are freely movable within the rings.

Preferably, the distance between each pair of the connection ropes is equal.

Preferably, the distance between each pair of the connection ropes 111 is not equal.

Preferably, the distance between each pair of the connection ropes makes the transmission ropes not be pulled out.

Preferably, the control units each are made by way of weaving which means that the connection rope is pulled laterally from the side rope corresponding thereto and connected to the separation rope. The transmission ropes extend alternatively through distances between the connection ropes. The distances between the connection ropes are adjustable.

The primary object of the present invention is to provide a safety rope assembly for curtains wherein the transmission ropes are restricted and not pulled out to ensure safety to kids.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the window curtain with the safety rope assembly of the present invention;

FIG. 2 shows the side view of the control unit of the safety rope assembly of the present invention;

FIG. 3 shows the method for manufacturing the control unit of the safety rope assembly of the present invention;

FIG. 4 shows that the shorter distance between the support ropes;

FIG. 5 shows that the connection ropes are in ring shape;

FIG. 6 shows that the transmission rope of the conventional window curtain is pulled out;

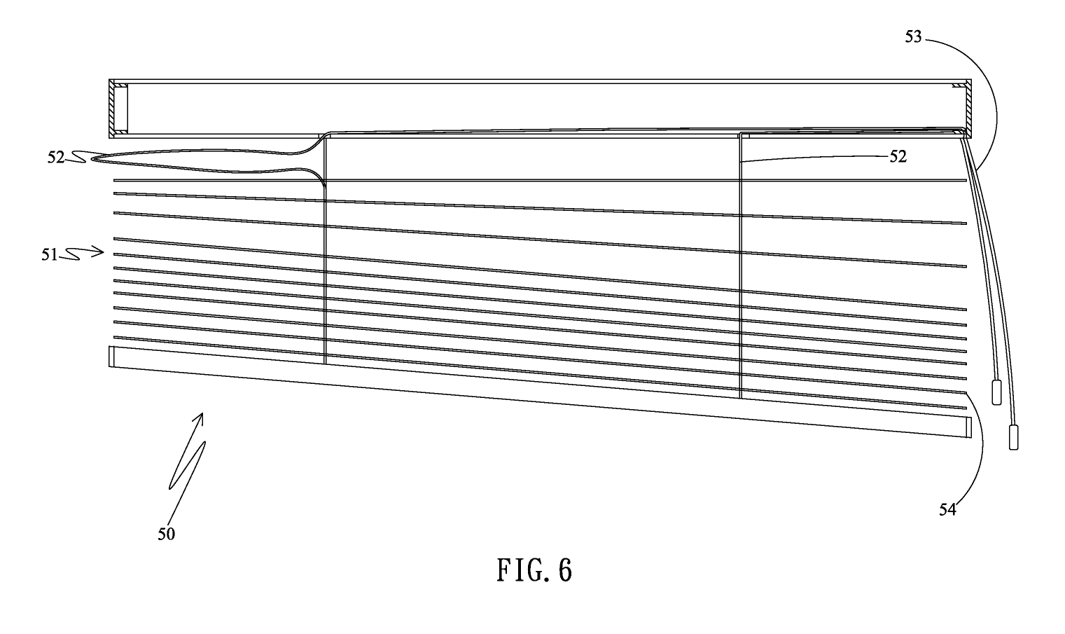

FIG. 7 shows another conventional window curtain, and

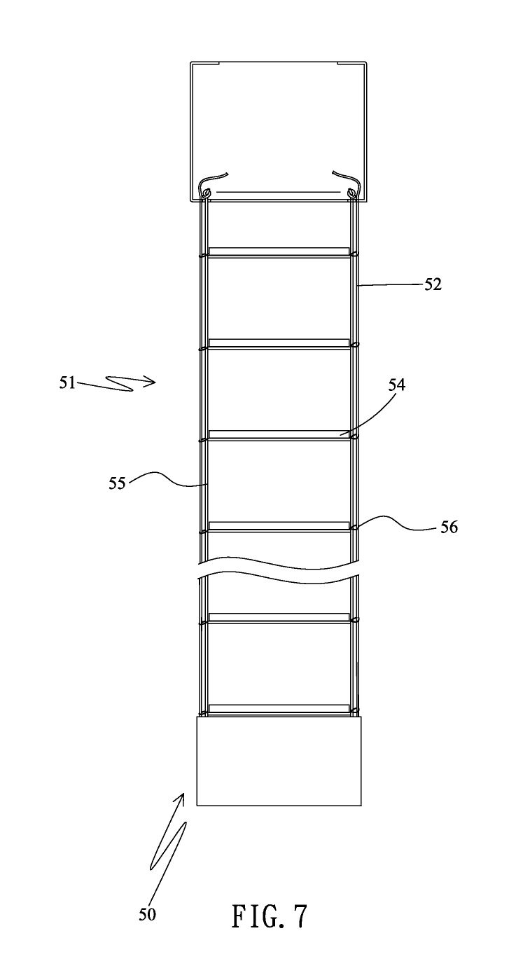

FIG. 8 shows that the transmission rope of the conventional window curtain in FIG. 7 is pulled out.

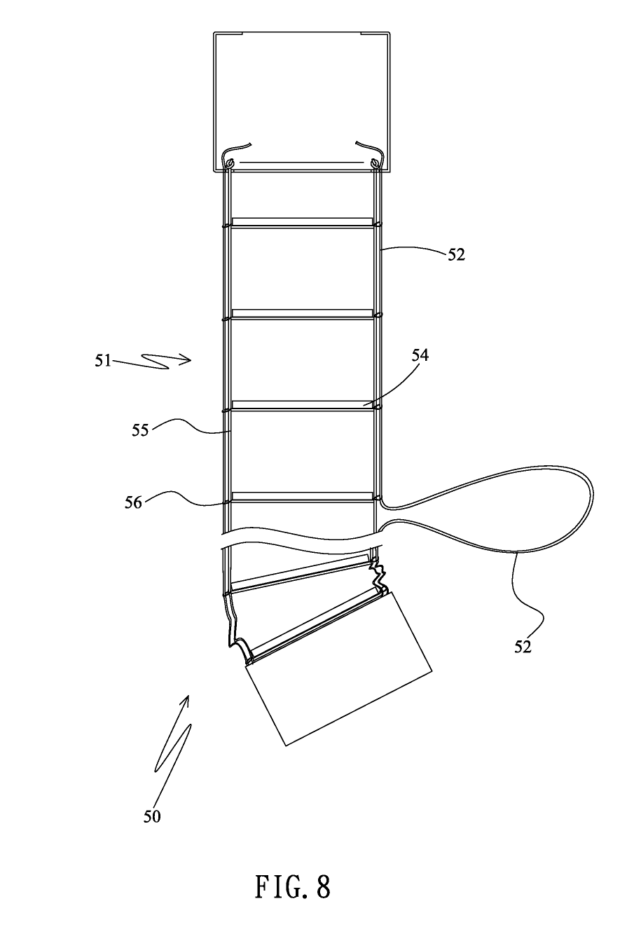

### DETAILED DESCRIPTION OF THE PREFERRED EMBODIMENT

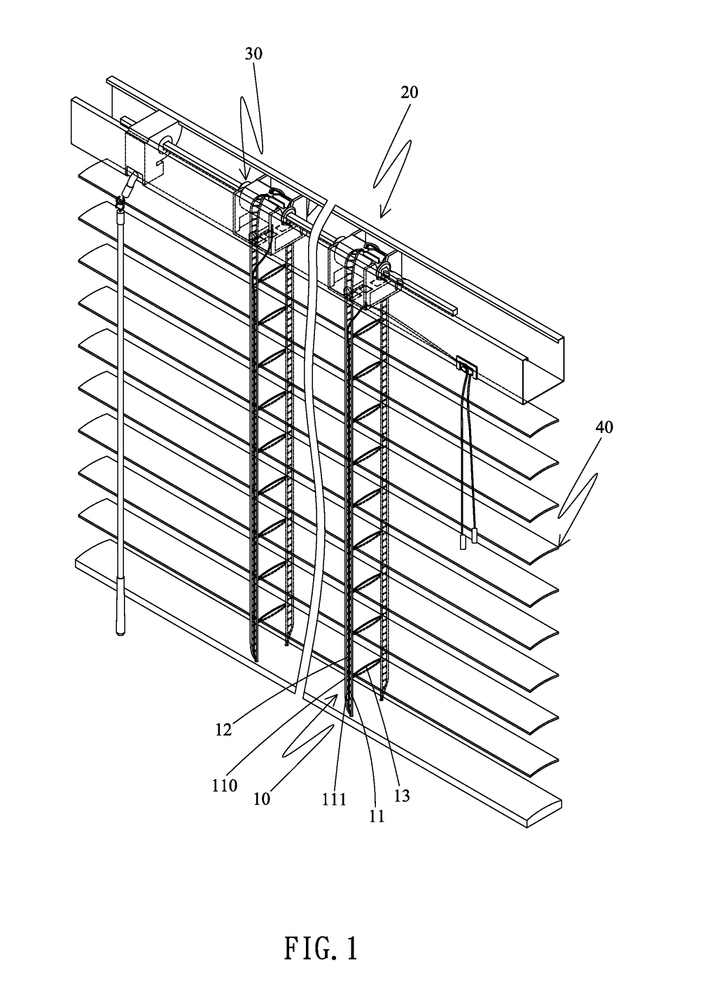

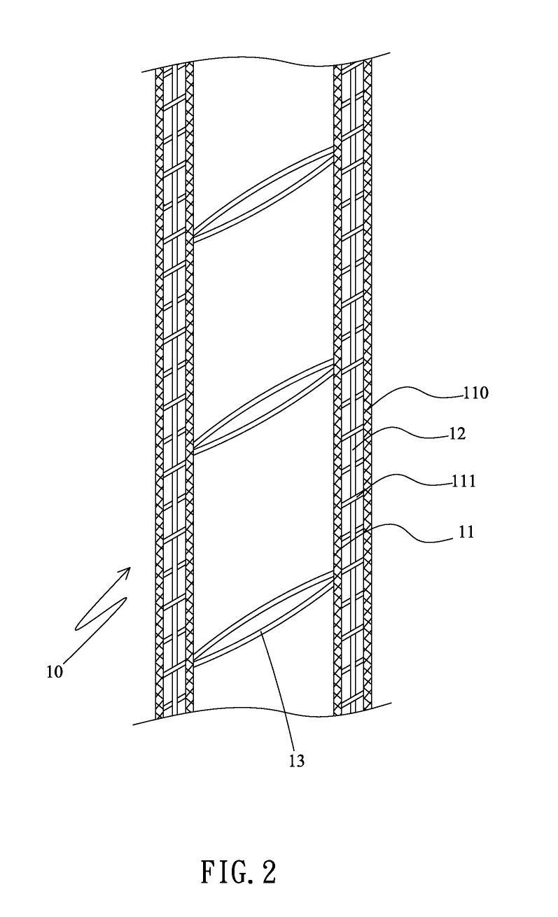

Referring to FIGS. 1 and 2, the safety rope assembly for a window curtain of the present invention comprises multiple control units 10 and each control unit 10 has multiple separation ropes 11, multiple transmission ropes 12 and multiple support ropes 13. Each of the separation ropes 11 has a side rope 110 located on outside thereof, and multiple connection ropes 111 are connected between the side rope 110 and the separation rope 11 on each side of the window curtain. The support ropes 13 are connected between the separation ropes 11 and slats 40 are supported on the support ropes 13. The transmission ropes 12 alternatively extend between the connection ropes 111. The side ropes 110 each are connected to an end of the connection rope 111 corresponding thereto.

The control units 10 each are made by way of weaving which means that the connection rope 111 is pulled laterally from the side rope 110 corresponding thereto and connected to the separation rope 11. The transmission ropes 12 extend alternatively through distances between the connection ropes 111, and the distances between the connection ropes 111 are adjustable.

The control units 10 are wrapped to the transmission units 30 in the head box 20. The slats 40 are located between the support ropes 13 so that when the control units 10 are operated, the transmission ropes 12 are restricted by the connection ropes 111 between the side ropes 110 and the separation ropes 11, and cannot be pulled out easily. Therefore, the transmission ropes 12 are restricted between the connection ropes 111, the side ropes 110 and the separation ropes 11 and cannot be pulled by kids.

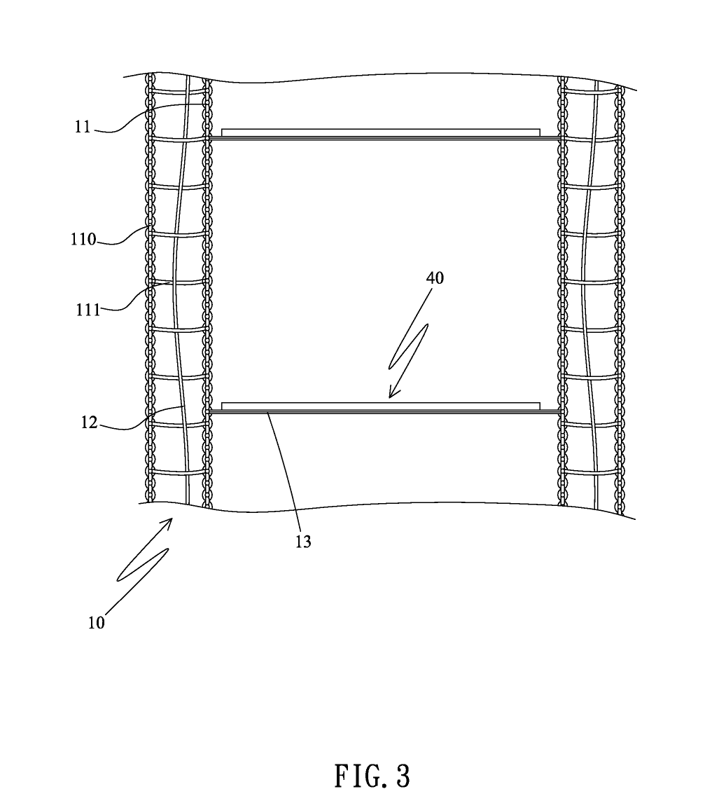

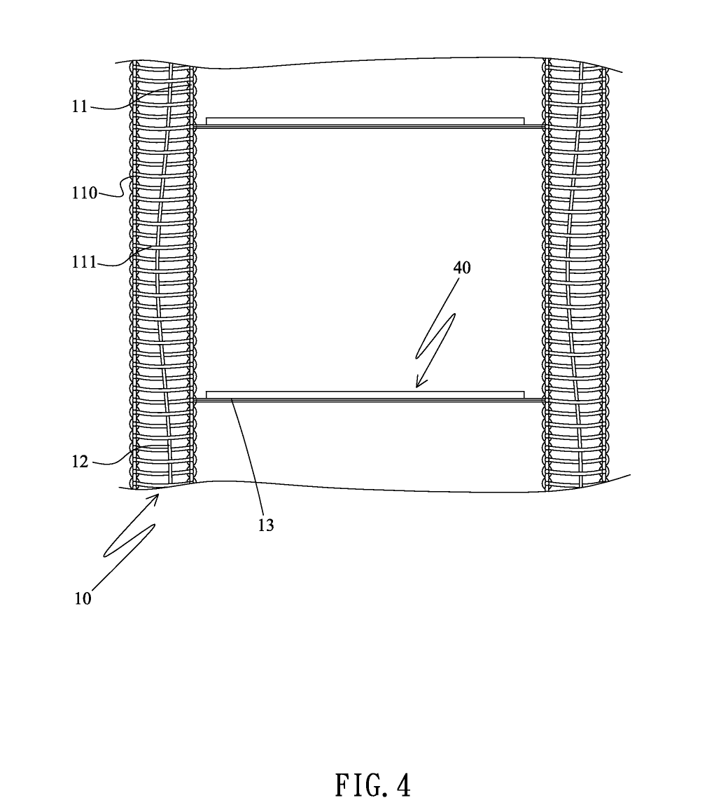

As shown in FIGS. 3 and 4, the distance between the support ropes 13 in this embodiment is shorter than that shown in FIGS. 1 and 2. The connection rope 111 is pulled laterally from the side rope 110 corresponding thereto and connected to the separation rope 11. The transmission ropes 12 extend alternatively through distances between the connection ropes 111, and the distances between the connection ropes 111 are adjustable. The distance between each pair of the connection ropes 111 is equal or not equal. The preferable distance is to restrict the transmission rope 12 from being pulled out. The distance is smaller than the fingers of kids so that the transmission rope 12 cannot be pulled out.

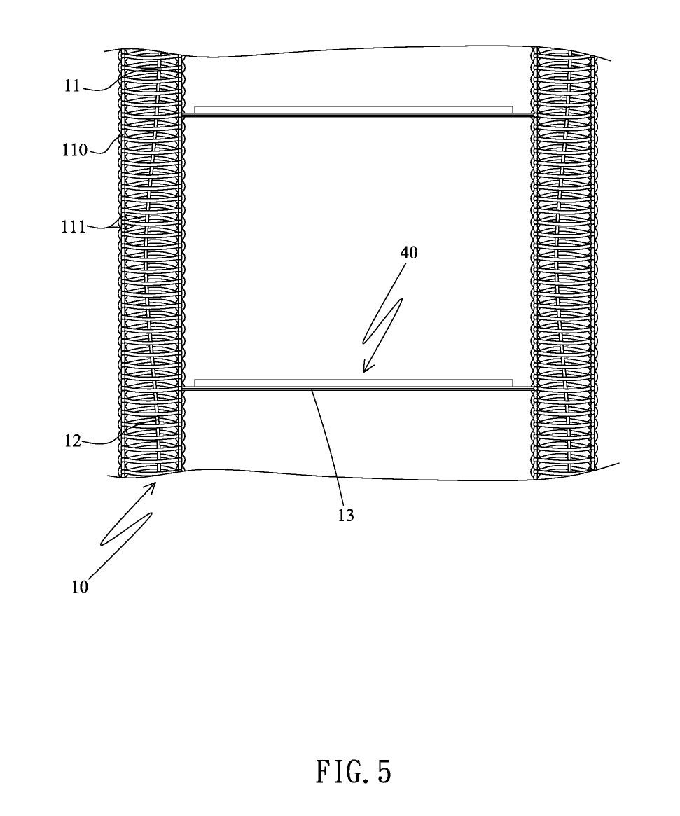

As shown in FIG. 5, the transmission ropes 12 are rings and has the same structure as that shown in FIGS. 1 and 2. The connection ropes 111 may be rings and the size of the rings allow the transmission rope 12 to be freely movable therein. The distances between the rings are limited so that the transmission ropes 12 cannot be easily pulled out. The transmission ropes 12 are also easily and steadily operated.

The present invention provides a safety rope assembly wherein the transmission ropes 12 are restricted by the connection ropes 111 between the side ropes 110 and the separation ropes 11, and the distance between the connection ropes 111 is smaller than the kid's finger so that kids cannot pull the transmission rope 12 out easily.

The transmission ropes 12 restricted between the connection ropes 111, the side ropes 110 and the separation ropes 11 are steadily and smoothly operated.

While we have shown and described the embodiment in accordance with the present invention, it should be clear to those skilled in the art that further embodiments may be made without departing from the scope of the present invention.

What is claimed is:

1. A safety rope assembly for curtains, comprising:
multiple control units and each control unit having multiple separation ropes, multiple transmission ropes and multiple support ropes, each of the separation ropes having a side rope located on outside thereof, multiple connection ropes connected between the side rope and the separation rope, the support ropes connected between the separation ropes, slats being supported on the support ropes, the transmission ropes alternatively extending between the connection ropes, the side ropes each connected to an end of the connection rope corresponding thereto.

2. The assembly as claimed in claim 1, wherein the connection ropes are rings and the transmission ropes extend through the rings.

3. The assembly as claimed in claim 2, wherein the transmission ropes are freely movable within the rings.

4. The assembly as claimed in claim 1, wherein a distance between each pair of the connection ropes is equal.

5. The assembly as claimed in claim 1, wherein a distance between each pair of the connection ropes is not equal.

6. The assembly as claimed in claim 1, wherein a distance between each pair of the connection ropes makes the transmission ropes not be pulled out.

7. The assembly as claimed in claim 1, wherein the control units each are made by way of weaving which means that the connection rope is pulled laterally from the side rope corresponding thereto and connected to the separation rope, the transmission ropes extend alternatively through distances between the connection ropes, the distances between the connection ropes are adjustable.
